(19) United States
(12) Patent Application Publication
(10) Pub. No.: US 2016/0073813 A1
(43) Pub. Date: Mar. 17, 2016

(54) Curtain Fixing Device

(71) Applicant: Li-Ming Cheng, Kaohsiung City (TW)

(72) Inventor: Li-Ming Cheng, Kaohsiung City (TW)

(21) Appl. No.: 14/483,231

(22) Filed: Sep. 11, 2014

(51) Int. Cl. A47H 1/142; A47H 1/022; F16B 7/18

(52) U.S. Cl. CPC A47H 1/142; F16B 7/182; A47H 1/022

(57) ABSTRACT

A curtain fixing device includes a hanging rod and first and second brackets. Each of the first and second brackets includes a spacer section and a fixing section connected to the spacer section. A projection of the spacer section onto the fixing section is located in the fixing section. The spacer section of the first bracket is coupled to a first end of the hanging rod. The spacer section of the second bracket is coupled to a second end of the hanging rod. The fixing sections of the first and second brackets are parallel to the hanging rod.

### BACKGROUND OF THE INVENTION

1. Field of the Invention

The present invention relates to a curtain fixing device and, more particularly, to a curtain fixing device that can be fixed to a wall for hanging a curtain.

2. Description of the Related Art

FIG. 1 shows a conventional curtain fixing device 9 including a first rod 91, a second rod 92, a left bracket 93, and a right bracket 94. An end of the first rod 91 receives an end of the second rod 92. The left bracket 93 is fixed to the other end of the first rod 91. The right bracket 94 is fixed to the other end of the second rod 92. The first rod 91 has a longitudinal axis extending in an X direction. The left bracket 93 extends from an end thereof connected to the first rod 91 in the X direction, a Y direction, and a Z direction to the other end of the left bracket 93. A portion of the left bracket 93 extending in the Z direction forms a coupling section 931 by which the left bracket 93 can be fixed to a wall. The right bracket 94 is a mirror image of the left bracket 93 and includes a coupling section 941 extending in the Z direction.

Since the left bracket 93 and the right bracket 94 extend in three dimensions and, thus, have a complicated structure, the left bracket 93 and the right bracket 94 have difficulties in formation and are not easy to manufacture while requiring a larger space for storage.

Furthermore, when mounting the conventional curtain fixing device 9 to the wall, since each of the left bracket 93 and the right bracket 94 has the coupling section 931, 941, the wall face above the window must be larger than the height of the coupling section 931, 941 for installing the conventional curtain fixing device 9. Namely, the conventional curtain fixing device 9 can not be installed if the wall face above the window is narrow. Thus, the installation condition of the conventional curtain fixing device 9 is strict and, thus, provides poor product utility.

Thus, improvement to the conventional curtain fixing device 9 is needed.

### SUMMARY OF THE INVENTION

An objective of the present invention is to provide a curtain fixing device that has a simple structure to allow easy manufacture while significantly reducing the space required for storage.

Another objective of the present invention is to provide a curtain fixing device requiring a smaller installation space to provide excellent production utility.

The present invention fulfills the above objectives by providing a curtain fixing device including a hanging rod and first and second brackets. Each of the first and second brackets includes a spacer section and a fixing section connected to the spacer section. A projection of the spacer section onto the fixing section is located in the fixing section. The spacer section of the first bracket is coupled to a first end of the hanging rod. The spacer section of the second bracket is coupled to a second end of the hanging rod. The fixing sections of the first and second brackets are parallel to the hanging rod.

An end of the spacer section of the first bracket can be connected to an end of the fixing section of the first bracket. The other end of the spacer section of the first bracket is a free end coupled to the first end of the hanging rod. The fixing section of the first bracket includes a central line passing through a free end of the fixing section of the first bracket and the end of the fixing section of the first bracket connected to the spacer section of the first bracket. An end of the spacer section of the second bracket can be connected to an end of the fixing section of the second bracket. The other end of the spacer section of the second bracket is a free end coupled to the second end of the hanging rod. The fixing section of the second bracket includes a central line passing through a free end of the fixing section of the second bracket and the end of the fixing section of the second bracket connected to the spacer section of the second bracket. A longitudinal axis of the hanging rod and the central lines of the fixing sections of the first and second brackets are located in the same reference plane and are parallel to each other.

The reference plane can be the plane of a three dimensional Cartesian coordinate system.

The curtain fixing device can further include two reinforcing members. Each of the two reinforcing members includes a support section. The spacer section of each of the first and second brackets can be a hollow tube. The support section of each of the two reinforcing members extends through the spacer section of one of the first and second brackets and abuts an inner face of the spacer section of the one of the first and second brackets.

The fixing section of each of the first and second brackets can include a plurality of through-holes adjacent to the free end thereof. Each of the two reinforcing members can include a coupling section connected to the support section thereof. The coupling section includes a plurality of through-holes. The plurality of through-holes of the coupling section of each of the two reinforcing members is aligned with the plurality of through-holes of the fixing section of one of the first and second brackets.

Each of the first and second ends of the hanging rod can include an engagement portion. The free end of the spacer section of each of the first and second brackets can include an engagement portion. The engagement portions of the first and second brackets respectively engage with the engagement portions of the hanging rod.

Each engagement portion of the hanging rod can include a supporting plate fixed to one of the first and second ends of the hanging rod. Each supporting plate has a screw hole in a center thereof. The engagement portion of each of the first and second brackets can include an anchor and a screw rod. Each anchor is fixed to the spacer section of one of the first and second brackets. Each screw rod is fixed to one of the anchors. Each screw rod includes an end extending beyond an end face of the free end of the spacer section of one of the first and second brackets. Each screw rod is in threading connection with the screw hole of one of the first and second brackets.

An outer periphery of each supporting plate of the hanging rod can be fixed to an inner periphery of one of the first and second ends of the hanging rod. Each supporting plate does not extend beyond a corresponding one of the first and second ends of the hanging rod.

The curtain fixing device can further include an auxiliary holder having a holding portion and a mounting portion. The hanging rod extends through and is held by the holding portion. The mounting portion is elongated and located in the reference plane. The mounting portion has a central line parallel to the longitudinal axis of the hanging rod.

The curtain fixing device according to the present invention has a simple structure, is easy to manufacture, and significantly reduces the space required for storage. Thus, the manufacturing cost can effectively be reduced, and the yield is increased. Furthermore, the storage space can be saved to reduce the costs for inventory and transportation. Furthermore, the curtain fixing device according to the present invention requires a smaller space for installation and can be used even if the wall face above the window is narrow, providing excellent product utility.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is an exploded, perspective view of a conventional curtain fixing device.

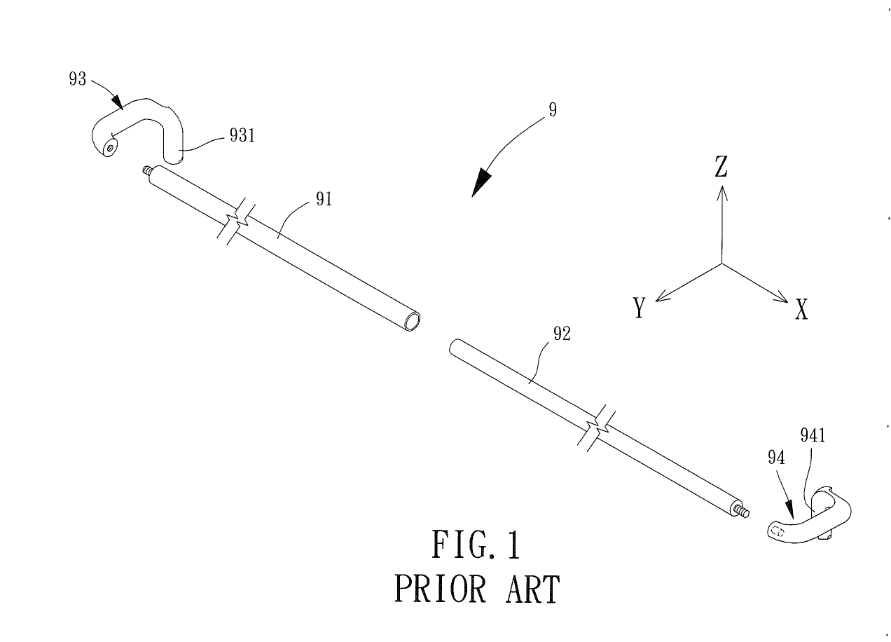

FIG. 2 is a perspective view of a curtain fixing device of an embodiment according to the present invention.

FIG. 3 is an exploded, perspective view of the curtain fixing device of the embodiment according to the present invention.

FIG. 4 is a schematic perspective view illustrating use of the curtain fixing device of the embodiment according to the present invention on a wall.

FIG. 5 is a cross sectional view illustrating use of the curtain fixing device of the embodiment according to the present invention with a narrower window.

FIG. 6 is a cross sectional view illustrating use of the curtain fixing device of the embodiment according to the present invention with a wider window.

FIG. 7 is a cross sectional view taken along section line 7-7 of FIG. 5.

### DETAILED DESCRIPTION OF THE INVENTION

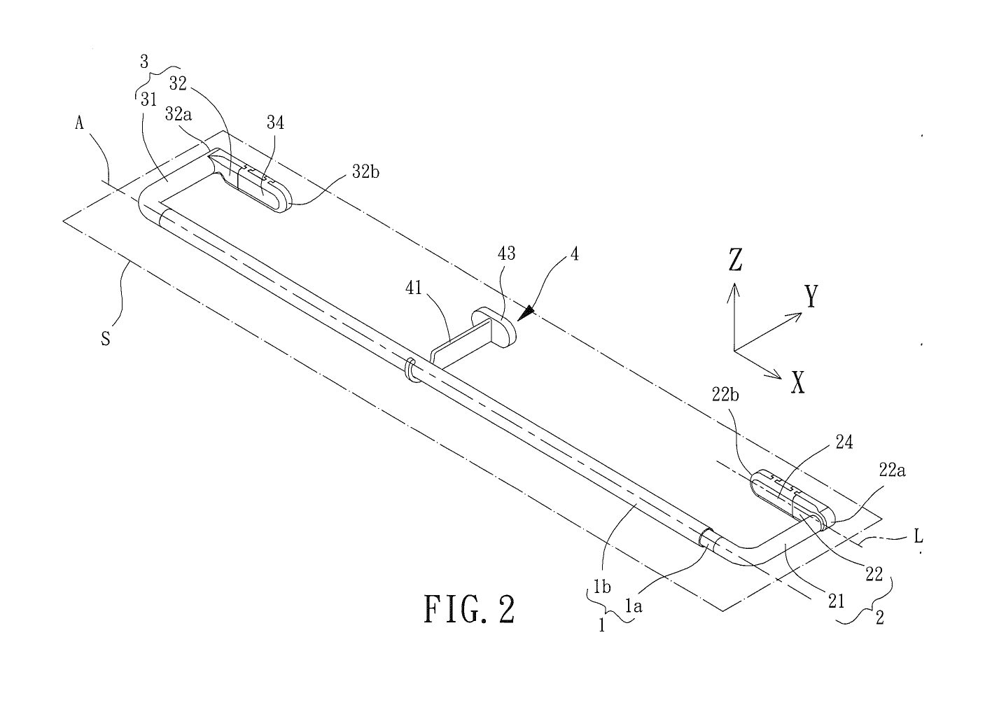

FIG. 2 shows a curtain fixing device of an embodiment according to the present invention. The curtain fixing device includes a hanging rod 1, a first bracket 2, and a second bracket 3. The first and second brackets 2 and 3 are respectively coupled to two ends of the hanging rod 1.

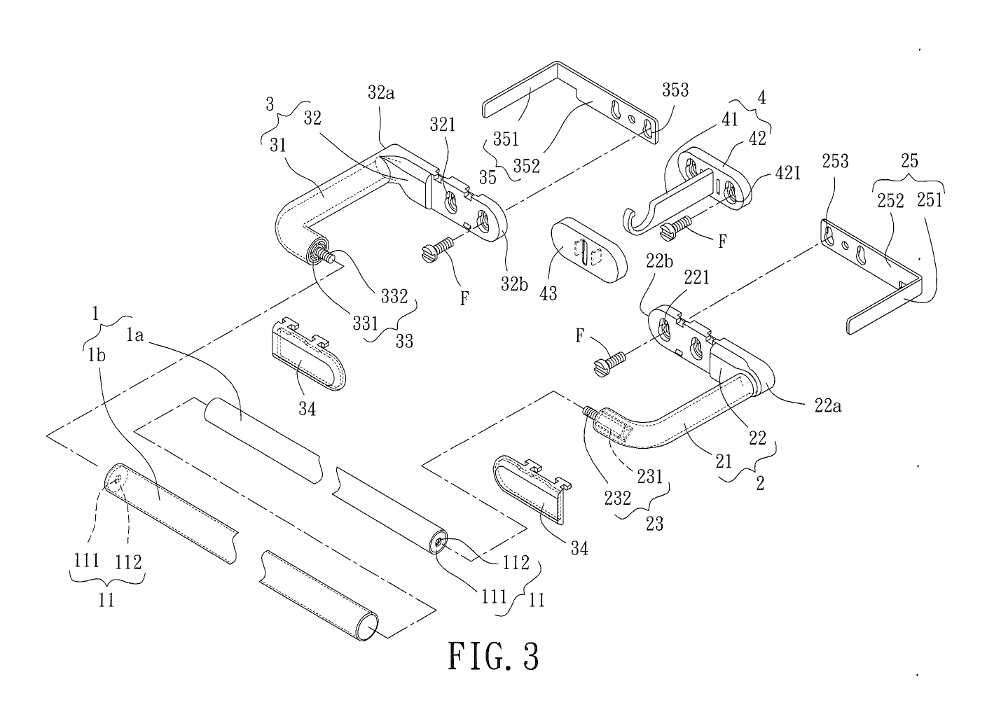

With reference to FIGS. 2 and 3, the hanging rod 1 is adapted to be used to hang a curtain. In this embodiment, the hanging rod 1 includes a first tube 1a and a second tube 1b. An end of the first tube 1a is received in an end of the second tube 1b. A user can adjust the overlapped length of the first tube 1a and the second tube 1b and, thus, telescope the hanging rod 1 to permit the hanging rod 1 to be used on windows of different widths. In other embodiments, the hanging rod 1 can include three or more telescopic tubes for use with wider windows, which can be appreciated by a person having ordinary skill in the art. Thus, the hanging rod 1 is not limited to the embodiment shown.

Each end of the hanging rod 1 includes an engagement portion 11 for coupling with the first and second brackets 2 and 3. In this embodiment, one of the engagement portions 11 of the hanging rod 1 is provided on the other end of the first tube 1a, and the other engagement portion 11 of the hanging rod 1 is provided on the other end of the second tube 1b.

Each engagement portion 11 can be of any type to couple with the corresponding first bracket 2 or second bracket 3. As a nonrestrictive example, each engagement portion 11 includes a supporting plate 111 fixed to an end of the first tube 1a or the second tube 1b by welding, bonding, tight coupling, or male/female coupling. Furthermore, each supporting plate 111 has a screw hole 112 in a center thereof. Each supporting plate 111 includes an outer periphery fixed to an inner periphery of the first tube 1a or the second tube 1b and does not extend beyond the first tube 1a or the second tube 1b.

The hanging rod 1 includes a longitudinal axis A located in a reference plane S. In this embodiment, the reference plane S is the X-Y plane of a three dimensional Cartesian coordinate system.

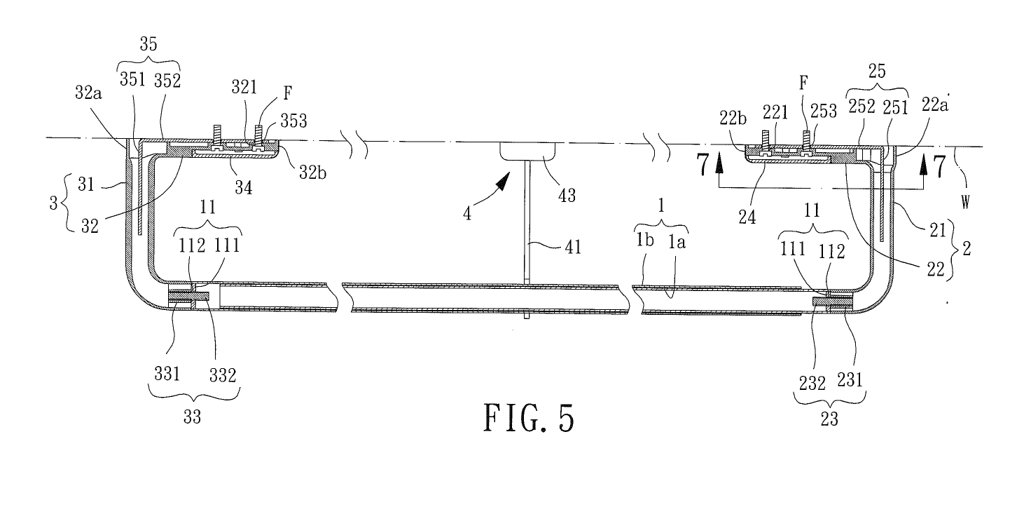

With reference to FIGS. 2 and 5, each of the first bracket 2 and the second bracket 3 includes a spacer section 21, 31 and a fixing section 22, 32. Each of the first bracket 2 and the second bracket 3 can be fixed to a wall W by the fixing section 22, 32. Each of the first bracket 2 and the second bracket 3 is coupled to the hanging rod 1 by the spacer section 21, 31 that keeps the hanging rod 1 from the wall W by a predetermined spacing.

The spacer section 21, 31 can be a hollow tube to reduce the weight. Furthermore, a projection of the spacer section 21, 31 onto the fixing section 22, 32 is located in the fixing section 22, 32. Namely, after each of the first bracket 2 and the second bracket 3 has been mounted to the wall W, the projection of the spacer section 21, 31 onto the wall W is located in the projection of the fixing section 22, 32 onto the wall W. Thus, each of the first bracket 2 and the second bracket 3 can be deemed as two dimensional and, thus, is easier to manufacture and occupies a smaller storage space in comparison with a conventional three dimensional curtain fixing bracket.

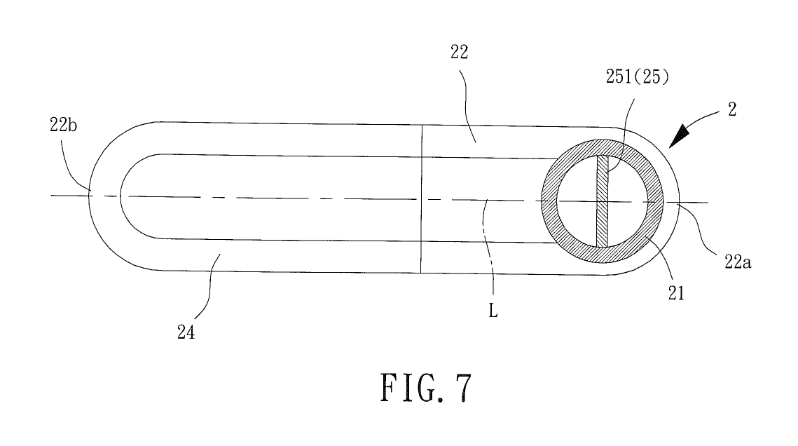

With reference to FIGS. 2 and 7, the fixing section 22, 32 includes a first end 22a, 32a and a second end 22b, 32b. The first end 22a, 32a of the fixing section 22, 32 can be connected to an end of the spacer section 21, 31, such that each of the second end 22b, 32b of the fixing section 22, 32 and the other end of the spacer section 21, 31 is a free end. The free end of the spacer section 21 is coupled to the other end of the first tube 1a. The free end of the spacer section 31 is coupled to the other end of the second tube 1b. The fixing section 22, 32 includes a central line L passing through the free end of the fixing section 22, 32 and the end of the fixing section 22, 32 connected to the spacer section 21, 31 (namely, the central line L passes through the first end 22a, 32a and the second end 22b, 32b of the fixing section 22, 32). The central line L is also located in the reference plane S and is parallel to the longitudinal axis A of the hanging rod 1.

With reference to FIGS. 2 and 3, each of the first bracket 2 and the second bracket 3 further includes an engagement portion 23, 33 on the free end of the spacer section 21, 31. The engagement portion 23, 33 engages with the engagement portion 11 of the first tube 1a or the second tube 1b. The engagement portion 23, 33 includes an anchor 231, 331 and a screw rod 232, 332. The anchor 231, 331 is fixed to the spacer section 21, 31 of the first bracket 2 or the second bracket 3. The screw rod 232, 332 is fixed to the anchor 231, 331. Furthermore, an end of the screw rod 232, 332 extends beyond an end face of the free end of the spacer section 21, 31. Thus, the screw rod 232, 332 can be in threading connection with the corresponding screw hole 112 to easily and rapidly couple the first bracket 2 or the second bracket 3 to the first tube 1a or the second tube 1b.

In this embodiment, the fixing section 22, 32 includes a plurality of through-holes 221, 321 adjacent to the free end thereof. A corresponding number of fasteners F extends through the through-holes 221, 321 to fix the first bracket 2 and the second bracket 3 to the wall W. Each of the first bracket 2 and the second bracket 3 can further include an escutcheon 24, 34 mounted to the fixing section 22, 32 to cover the through-holes 221, 321 and the fasteners F.

Each of the first bracket 2 and the second bracket 3 can further include a reinforcing member 25, 35. The reinforcing member 25, 35 includes a support section 251, 351 and a coupling section 252, 352 connected to the support section 251, 351. The support section 251, 351 extends through the spacer section 21, 31 and abuts an inner face of the spacer section 21, 31 (see FIG. 7). The coupling section 252, 352 includes a plurality of through-holes 253, 353 aligned with the through-holes 221, 321. The fasteners F can extend through the through-holes 253, 353. Thus, the structural strength of the first bracket 2 and the second bracket 3 can be reinforced by the reinforcing members 25 and 35 to avoid breakage of the first bracket 2 and the second bracket 3 due to an excessive load.

Note that the structure of the second bracket 3 is a mirror image of the first bracket 2.

The curtain fixing device according to the present invention can further include an auxiliary holder 4 having a holding portion 41 and a mounting portion 42. The hanging rod 1 extends through and is held by the holding portion 41. The holding portion 41 abuts an outer periphery of the hanging rod 1. Thus, the holding portion 41 and the first and second brackets 2 and 3 together support the hanging rod 1. In this embodiment, the mounting portion 42 is elongated and located in the reference plane S. The central line of the mounting portion 42 is also parallel to the longitudinal axis A of the hanging rod 1. Thus, when the auxiliary holder 4 is fixed to the wall W by the mounting portion 42, the mounting portion 42 will not occupy much space in Z direction. In a nonrestrictive example, the mounting portion 42 includes a plurality of through-holes 421 evenly distributed on two sides of the holding portion 41, and a corresponding number of fasteners F extends through the through-holes 421 to fix the mounting portion 42 to the wall W. The auxiliary holder 4 can also have an escutcheon 43 mounted to the mounting portion 42 to cover the through-holes 421 and the fasteners F.

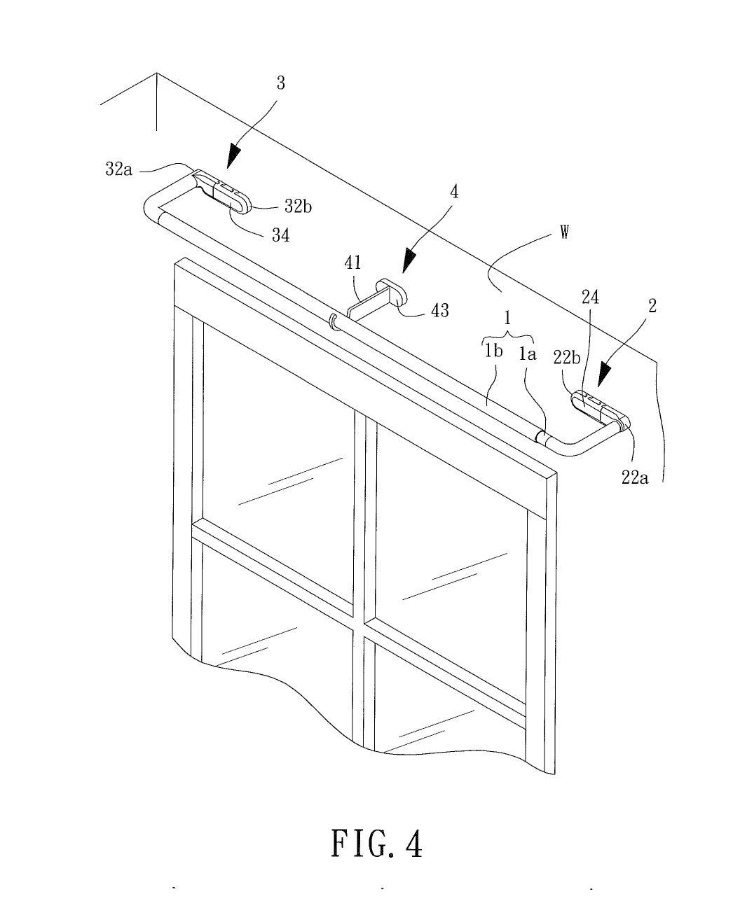

With reference to FIG. 4, with the curtain fixing device according to the present invention having the above structure, the first bracket 2 and the second bracket 3 can be respectively coupled to two ends of the hanging rod 1, and the first and second brackets 2 and 3 can be fixed to the wall W to finish installation of the curtain fixing device. In an embodiment including the auxiliary holder 4, the auxiliary holder 4 should be firstly mounted to the wall W before mounting the first and second brackets 2 and 3 to the wall W, assuring that the hanging rod 1 can extend through the auxiliary holder 4. Then, the first and second brackets 2 and 3 can be fixed to the wall W such that the auxiliary holder 4 and the first and second brackets 2 and 3 can be fixed to the wall W to together support the hanging rod 1.

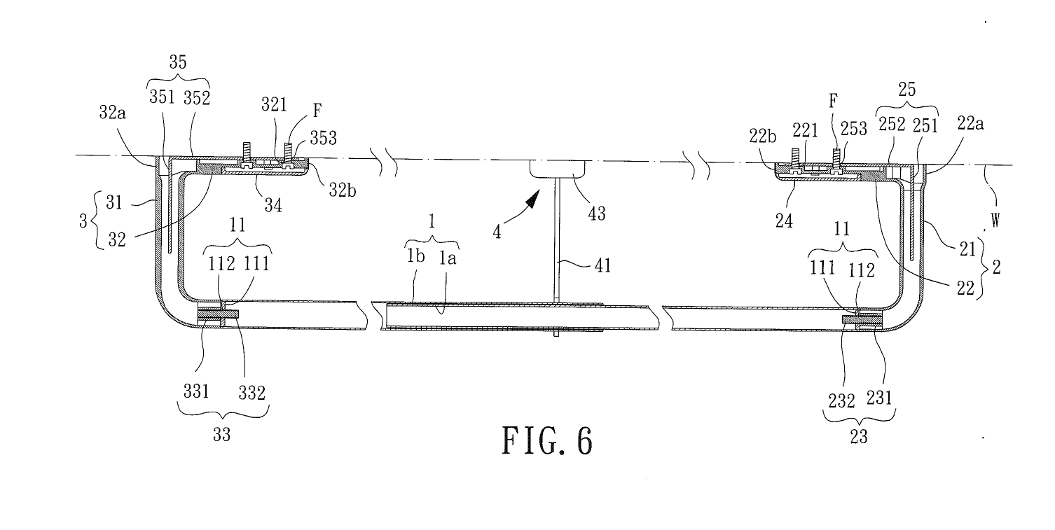

With reference to FIG. 5, when the curtain fixing device is mounted to a narrower window, the overlapped length of the first tube 1a and the second tube 1b of the hanging rod 1 can be larger such that the hanging rod 1 is shorter for the narrower window. With reference to FIG. 6, on the other hand, when the curtain fixing device is mounted to a wider window, the overlapped length of the first tube 1a and the second tube 1b of the hanging rod 1 can be smaller such that the hanging rod 1 is shorter for the wider window.

In view of the foregoing, the first and second brackets 2 and 3 of the curtain fixing device according to the present invention can be deemed as extending only in a two dimensional plane by arranging the central lines L of the first and second brackets 2 and 3 and the longitudinal axis A of the hanging rod 1 in the same plane S, such that the first and second brackets 2 and 3 have a simpler outline and are easy to manufacture and assemble. Furthermore, the space required for storage can significantly be reduced, which not only increases the number of cargo loaded per unit space to reduce the average freight fee but increases the utilization rate of the inventory space to reduce the inventory cost.

Furthermore, the portions (i.e., the fixing sections 22 and 32) of the first and second brackets 2 and 3 of the curtain fixing device according to the present invention coupled to the wall W are substantially parallel to the hanging rod 1, such that the space required for installing the curtain fixing device can be smaller. Thus, the fixing sections 22 and 32 of the first and second brackets 2 and 3 of the curtain fixing device will not occupy a larger space above the window. As a result, the curtain fixing device can even be mounted to a narrower space above the window, providing excellent product utility.

It can be appreciated that the anchor 231, 331 and the screw rod 232, 332 can be formed on each engagement portion 11 of the hanging rod 1 of the curtain fixing device according to the present invention, and the screw holes 112 can be formed in the engagement portions 23 and 33 of the first and second brackets 2 and 3, which can be appreciated by a person having ordinary skill in the art. However, the overall length of the hanging rod 1 will be increased by the screw rods 232, 332 on the hanging rod 1. Thus, the embodiment of arranging the screw rods 232, 332 on the first and second brackets 2 and 3 shown in FIG. 3 is preferred to reduce the storage space required for the hanging rod 1, further increasing the utilization rate of the inventory space.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A curtain fixing device comprising:
a hanging rod including first and second ends; and
first and second brackets, with each of the first and second brackets including a spacer section and a fixing section connected to the spacer section, with a projection of the spacer section onto the fixing section located in the fixing section, with the spacer section of the first bracket coupled to the first end of the hanging rod, with the spacer section of the second bracket coupled to the second end of the hanging rod, and with the fixing sections of the first and second brackets being parallel to the hanging rod.

2. The curtain fixing device as claimed in claim 1, with the spacer section of the first bracket including an end connected to an end of the fixing section of the first bracket, with the spacer section of the first bracket further including another end that is a free end coupled to the first end of the hanging rod, with the fixing section of the first bracket including a central line passing through a free end of the fixing section of the first bracket and the end of the fixing section of the first bracket connected to the spacer section of the first bracket, with the spacer section of the second bracket including an end connected to an end of the fixing section of the second bracket, with the spacer section of the second bracket further including another end that is a free end coupled to the second end of the hanging rod, with the fixing section of the second bracket including a central line passing through a free end of the fixing section of the second bracket and the end of the fixing section of the second bracket connected to the spacer section of the second bracket, with the hanging rod including a longitudinal axis, with the longitudinal axis of the hanging rod and the central lines of the fixing sections of the first and second brackets located in a same reference plane and parallel to each other.

3. The curtain fixing device as claimed in claim 2, wherein the reference plane is a plane of a three dimensional Cartesian coordinate system.

4. The curtain fixing device as claimed in claim 2, further comprising: two reinforcing members, with each of the two reinforcing members including a support section, with the spacer section of each of the first and second brackets being a hollow tube, with the support section of each of the two reinforcing members extending through the spacer section of one of the first and second brackets and abutting an inner face of the spacer section of the one of the first and second brackets.

5. The curtain fixing device as claimed in claim 4, with the fixing section of each of the first and second brackets including a plurality of through-holes adjacent to the free end thereof, with each of the two reinforcing members including a coupling section connected to the support section thereof, with the coupling section including a plurality of through-holes, with the plurality of through-holes of the coupling section of each of the two reinforcing members aligned with the plurality of through-holes of the fixing section of one of the first and second brackets.

6. The curtain fixing device as claimed in claim 2, with each of the first and second ends of the hanging rod including an engagement portion, with the free end of the spacer section of each of the first and second brackets including an engagement portion, and with the engagement portions of the first and second brackets respectively engaged with the engagement portions of the hanging rod.

7. The curtain fixing device as claimed in claim 6, with each engagement portion of the hanging rod including a supporting plate fixed to one of the first and second ends of the hanging rod, with each supporting plate having a screw hole in a center thereof, with the engagement portion of each of the first and second brackets including an anchor and a screw rod, with each anchor fixed to the spacer section of one of the first and second brackets, with each screw rod fixed to one of the anchors, with each screw rod including an end extending beyond an end face of the free end of the spacer section of one of the first and second brackets, and with the each screw rod being in threading connection with the screw hole of one of the first and second brackets.

8. The curtain fixing device as claimed in claim 7, with each supporting plate of the hanging rod including an outer periphery fixed to an inner periphery of one of the first and second ends of the hanging rod, and with each supporting plate not extending beyond a corresponding one of the first and second ends of the hanging rod.

9. The curtain fixing device as claimed in claim 2, further comprising: an auxiliary holder including a holding portion and a mounting portion, with the hanging rod extending through and held by the holding portion, with the mounting portion being elongated and located in the reference plane, and with the mounting portion having a central line parallel to the longitudinal axis of the hanging rod.
